(19) United States
(12) Patent Application Publication
(10) Pub. No.: US 2009/0228928 A1
(43) Pub. Date: Sep. 10, 2009

(54) Method of receiving broadcast signals and apparatus for receiving broadcast signals

(76) Inventors: Joon Hui LEE, Seoul (KR); Jong Yeul SUH, Seoul (KR); Jae Hyung SONG, Seoul (KR)

Correspondence Address: MCKENNA LONG & ALDRIDGE LLP, 1900 K STREET, NW, WASHINGTON, DC, 20006, US

(21) Appl. No.: 12/382,062

(22) Filed: Mar. 6, 2009

Related U.S. Application Data
(60) Provisional application No. 61/034,487, filed on Mar. 7, 2008.
(60) Provisional application No. 61/037,333, filed on Mar. 18, 2008.

(30) Foreign Application Priority Data
Mar. 4, 2009 (KR) 10-2009-0018651

(51) Int. Cl. H04N 5/445; H04N 7/173

(52) U.S. Cl. 725/55; 725/134; 725/110

(57) ABSTRACT

The present invention relates to a method of receiving broadcast signals and an apparatus for receiving broadcast signals. The apparatus includes a receiving unit configured to receive a broadcast signal, a demodulator configured to demodulate the broadcast signal, a demultiplexer configured to demultiplex the broadcast signal, a storage device configured to store a replacement segment to replace a specific portion of a broadcast stream, and segment-related information describing a replaceable segment included in a broadcast stream, from the demultiplexed broadcast signal, a controller configured to control uploading the stored replacement segment or downloading the replacement segment and to insert the stored replacement segment into the broadcast stream according to the segment-related information; and a decoder configured to decode a broadcast stream.

This application claims the priority benefit of Korean Application No. 10-2009-0018651, filed on Mar. 4, 2009, which is hereby incorporated by reference as if fully set forth therein.

This application claims the benefit of U.S. Provisional Application No. 61/034,487, filed on Mar. 7, 2008, titled “METHOD OF PROCESSING REPLACEABLE STREA AND TIME SLOT INFORMATION”, which is hereby incorporated by reference.

And this application claims the benefit of U.S. Provisional Application No. 61/037,333, filed on Mar. 18, 2008, titled “SEAMLESS SWITCHING METHOD FOR NON-REAL-TIME AND REAL-TIME CONTENTS”, which is hereby incorporated by reference.

### BACKGROUND OF THE INVENTION

1. Field of the Invention

The present invention relates to a method of receiving broadcast signals and an apparatus for receiving broadcast signals.

2. Discussion of the Related Art

A digital television (DTV) can provide not only video and audio services, which are conventional TV services, but can now also provide various other services. For example, the DTV can provide an Electronic Program Guide (EPG) or the like to the user and can simultaneously provide broadcast services received through 2 or more channels. Especially, the number of services that a broadcast signal receiver can provide has been significantly increased since the broadcast signal receiver has been equipped with a large-capacity storage device and has been connected to the Internet or data communication channels which enable bidirectional communication.

In such environments, recently, a method of receiving broadcast signals to provide a service combining a real-time broadcast service and a non-real-time broadcast service and an apparatus for receiving broadcast signals to enable implementation of the method are under development.

### SUMMARY OF THE INVENTION

Accordingly, the present invention is directed to a method for transmitting and receiving broadcast signals and an apparatus for receiving broadcast signals that substantially obviate one or more problems due to limitations and disadvantages of the related art.

An object of the present invention is to provide a method of receiving broadcast signals and an apparatus for receiving broadcast signals which can efficiently combine and provide a real-time broadcast service and a non-real-time broadcast service.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve the object, one embodiment of the present invention discloses a method of receiving broadcast signals by a broadcast receiver including a storage medium. The method includes receiving a replacement segment to replace a specific portion of a broadcast stream, and segment-related information describing the replaceable segment included in a broadcast stream, receiving a broadcast stream, inserting the stored replacement segment into the received broadcast stream using the segment-related information and displaying the broadcast stream with the inserted replacement segment.

The segment-related information includes position information of the replaceable segment in the broadcast stream, and the receiving of the broadcast stream includes identifying the replaceable segment and storing the broadcast stream in which the identified replaceable segment is skipped. The segment-related information is received through one of a transport packet, an IP packet, and a file object in the received broadcast stream. The segment-related information includes a start time of a replaceable segment in the broadcast stream, a type of the replaceable segment, and duration of the replaceable segment. The segment-related information is included in one of an Event Information Table (EIT), a Program Map Table (PMT), and a video stream packet. The segment-related information is defined by a table of broadcast description information and is transmitted via a table section. An identifier of a packet through which the table section is transmitted may be included in Master Guide Table (MGT). The table is transmitted through a stream defined by a separate stream_type.

In another aspect, the present invention provides an apparatus for receiving broadcast signals. The apparatus includes a receiving unit configured to receive a broadcast signal, a demodulator configured to demodulate the broadcast signal, a demultiplexer configured to demultiplex the broadcast signal, a storage device configured to store a replacement segment to replace a specific portion of a broadcast stream, and segment-related information describing a replaceable segment included in a broadcast stream, from the demultiplexed broadcast signal; a controller configured to control uploading the stored replacement segment or downloading the replacement segment and to insert the stored replacement segment into the broadcast stream according to the segment-related information; and a decoder configured to decode a broadcast stream.

When the broadcast stream is stored in the storage device, the controller controls the storage device to store the broadcast stream in which a replaceable segment included in the broadcast stream is skipped. When the controller uploads the stored broadcast stream from the storage device, the segment-related information includes information pointer information indicating a position for insertion of the replacement segment. The controller stores the segment-related information in the storage device. The segment-related information includes a start time of a replaceable segment in the broadcast stream, a type of the replaceable segment, and duration of the replaceable segment. the segment-related information is included in one of an Event Information Table (EIT), a Program Map Table (PMT), and a video stream packet. The segment-related information may be received in the broadcast stream or may be generated by a storage controller controlling the storage. When the segment-related information is included in the broadcast signal, the apparatus further comprises a file decoder that decodes the replacement segment and the file decoder decodes the segment-related information included in one of a transport packet, an IP packet, and a file object.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a concept of providing a real-time (RT) service and a non-real-time (NRT) service;

FIG. 2 is a conceptual diagram illustrating an RT service stream including a replaceable segment;

FIG. 3 illustrates an example of identification information that enables identification of a replaceable segment;

FIG. 4 illustrates an example of values of a segment type illustrated in FIG. 3;

FIG. 5 illustrates an example of EIT;

FIG. 6 illustrates an example of EIT when description information of a replaceable segment is transmitted through the EIT;

FIG. 7 illustrates an embodiment of an Ad_segment_info_table_section (AST) that describes a segment included in a broadcast stream;

FIG. 8 illustrates an embodiment of a method of receiving broadcast signals according to an embodiment of the present invention;

FIG. 9 illustrates an example wherein a portion of broadcast content is replaced with a specific broadcast segment;

FIG. 10 illustrates an example wherein a replaceable segment in content for reproduction is replaced with stored content; and

FIG. 11 illustrates an apparatus for receiving broadcast signals according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention provides an embodiment wherein an apparatus for receiving broadcast signals receives a real-time service and a non-real-time service and provides a combination of the real-time and non-real-time services to the user. The term “splicing” refers to coupling of two or more independent streams into one stream. The following description will be given of embodiments wherein two services are coupled and provided. In the following description, the term “segment-related information” refers to information describing a replaceable segment or information indicating a position for replacement or insertion of the replaceable segment. The segment-related information will also be referred to as “segment description information” or “metadata (or index)”. Details of the segment-related information will be described later.

One example of the non-real-time service is target advertising. Target advertising is a service which allows a receiver capable of receiving non-real-time services to selectively store an advertisement stream according to user preference and to output a previously stored advertisement. The receiver that implements target advertising may include a storage device capable of storing advertisements, for example a hard disk or a flash memory.

The receiver can output [transmit] an advertisement stored for implementing a target advertising service through insertion in a real-time broadcast stream or a previously stored stream. Here, the receiver needs to be able to seamlessly mix a stream received in real time with a previously stored stream. In order to implement this function, the receiver needs to receive information, indicating that a portion (for example, a segment) in a real-time broadcast stream can be replaced with a previously stored stream, in a broadcast signal. For example, the receiver can previously and correctly obtain information such as the start and end times of a replaceable portion in a real-time broadcast stream. However, a replaceable portion may occur irregularly or abruptly. Specifically, a broadcast event may abruptly occur. For example, when an inning change occurs during a baseball broadcast event, an advertisement event may be abruptly inserted and transmitted between the innings. In this case, the receiver cannot know whether or not the advertisement event is replaceable content. Accordingly, in the following description, an embodiment of the present invention suggests a method for transmitting information for signaling or notification of a replaceable portion included in broadcast content and transmitting information regarding a replacement portion.

Similar situations may also occur when a portion of content stored in the receiver is replaced with other content that was stored before or after the content. A receiver including a storage device can store and then provide a non-real-time service, such as a target advertising service, an advertisement insertion service, a push VOD service, or a stream providing additional information, to the user.

The receiver receives broadcast content in real time or in non-real time and identifies and stores a replaceable portion in the broadcast content. Before and after broadcast content is stored in the receiver, the receiver can store content received through a non-real-time (NRT) service, for example content such as target advertising. Then, in the case where the receiver reproduces the broadcast content, the receiver can replace a replaceable portion in the broadcast content with the stored content of the NRT service to reproduce the broadcast content including the stored content replacing the replaceable portion.

To accomplish this, there is a need to provide information regarding the replaceable portion (for example, a segment) in the broadcast content and to switch part of the stored content to other stored content. Detailed embodiments of this method will be described below.

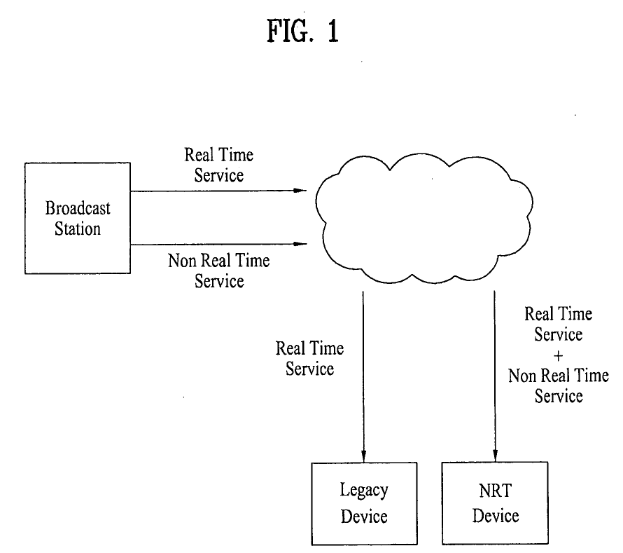

FIG. 1 illustrates a concept of providing a real-time (RT) service and a non-real-time (NRT) service.

The NRT service is a service that transmits a program using a specific broadcast channel, particularly using a surplus bandwidth included in a broadcast channel. The transfer rate of the NRT service is low and thus it is provided for reproduction after storage rather than for real-time watching.

The RT service is a service that is received and displayed in real time, similar to current terrestrial broadcasts. For example, the broadcast station can provide RT services and can transmit content of news clips, weather information, advertisement, push VOD or the like. The conventional broadcast receiver can receive RT services and cannot receive NRT services. However, a broadcast receiver according to embodiments described below can combine NRT services and RT services to provide a variety of services. For example, an RT service and an NRT service can be received in MPEG2 transport packets in a broadcast channel and it is possible to allocate a specific PID for carrying an NRT service.

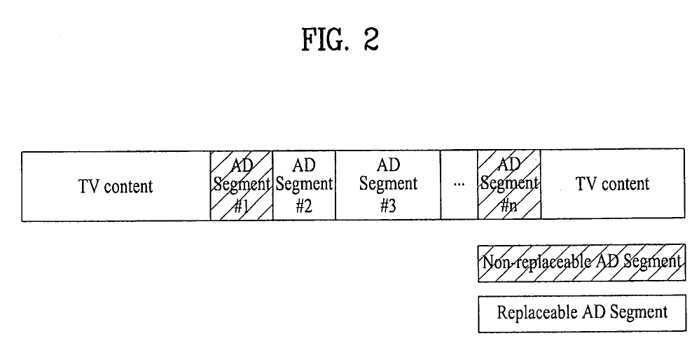

FIG. 2 is a conceptual diagram illustrating an RT service stream including a replaceable segment.

In the example of FIG. 2, advertisement segments are inserted between streams which carry broadcast content. Unlike this example, the replaceable segment may be a segment which carries content for providing specific scenes included in broadcast content.

In this example, one part of advertisement segments may be a replaceable segment and another part thereof may be a non-replaceable segment. The size of the advertisement segment may vary according to the length of the advertisement. That is, the advertisement segment may be variable in size. For the replaceable advertisement segment, the start time, the end time, or the duration of the advertisement may be provided as in embodiments described later. Upon receiving such a replaceable segment, the receiver can replace the replaceable segment with an advertisement segment such as a user-customized advertisement segment that has been received in non-real time before the RT stream is received.

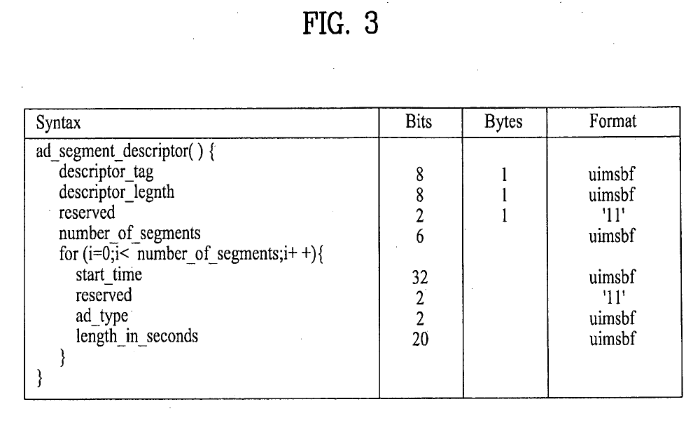

FIG. 3 illustrates an example of identification information that enables identification of a replaceable segment. In FIG. 3, the identification is illustrated as a descriptor. The following is a detailed description of the descriptor. The descriptor can describe a replaceable segment included in a stream. The title of the descriptor is shown as an ad_segment_descriptor( ) for the sake of convenience.

In ad_segment_descriptor( ), a descriptor_tag field and a descriptor_length field represent the identifier and length of the descriptor, respectively. Since the conventional receiver cannot identify this descriptor from the descriptor_tag field, it is possible to guarantee backward compatibility.

A reserved field represents a reserved area and a number_of_segments field represents the number of replaceable segments included in the stream.

The start_time field represents the start time of the replaceable segment. For example, in the start_time field, the start time of the replaceable segment can be set in seconds using the GPS time, namely, the number of seconds since 00:00:00 UTC Jan. 6, 1980.

The ad_type field represents the type of the segment. Examples of this field will be described later.

The length_in_seconds field represents the duration of the replaceable segment. For example, the length_in_seconds field can represent the duration of the replaceable segment in seconds.

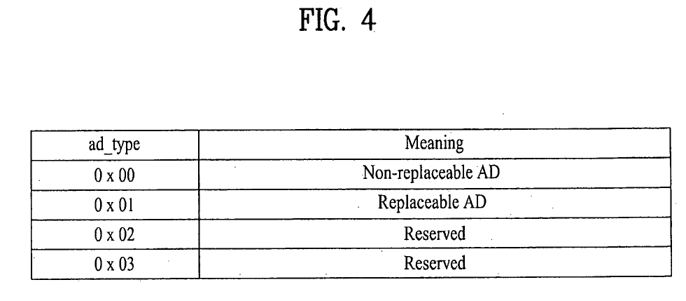

FIG. 4 illustrates example values of the type of the segment illustrated above. In FIG. 4, “0x00” indicates a non-replaceable advertisement segment and “0x01” indicates a replaceable advertisement segment. In addition, “0x02” and “0x03” are set as reserved values. The descriptor illustrated above may include an Event Information Table (EIT) or a Program Map Table (PMT) defined in the PSI/SI or the PSI/PSIP.

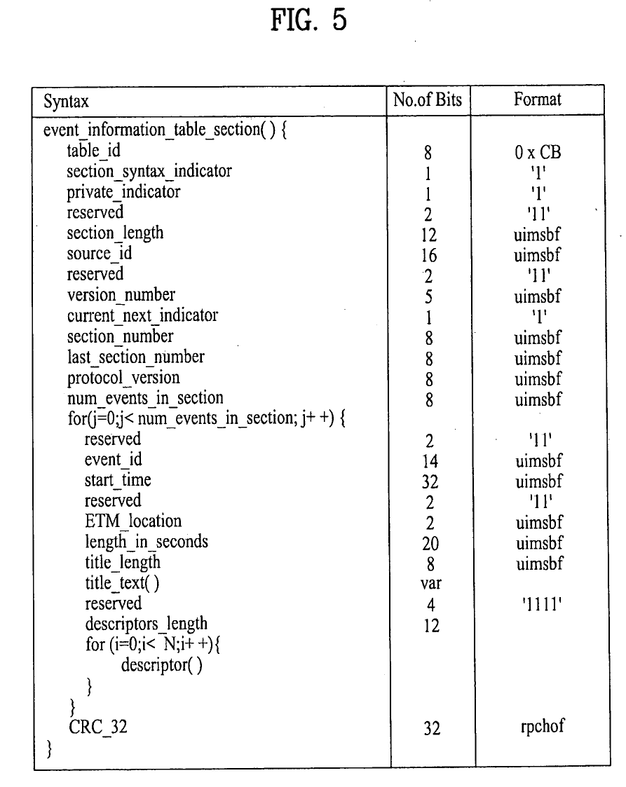

FIG. 5 illustrates an example of EIT. The following is a description of the EIT as information carrying the descriptor describing the replaceable segment.

A table_id field (8 bits) represents an identifier of an event information table section. section_syntax_indicator (1 bit) indicates that the EIT is an MPEG long-form syntax.

A private_indicator field (1 bit) is set to “1” in the PSIP.

A reserved field (2 bits) is a reserved area set to “11”.

A section_length field (12 bits) represents the length of an EIT section.

A source_id field (16 bits) represents an identifier of a source associated with the EIT.

A reserved field (2 bits) is a reserved area set to “11”.

A version_number field (5 bits) represents the version of a table section. The value of the version_number field is changed when the content of the table is changed.

A current_next_indicator field (1 bit) represents whether the EIT table section is applied to the current table or to a next table.

A section_number field (8 bits) represents the section number of a section through which event information is carried, namely, the sequence number of the section. This value starts from “0” and is increased by “1” when the section number is increased by “1”.

A last_section_number field (8 bits) represents the last section number of the table section.

A protocol_version field (8 bits) represents the protocol version of this table section.

A num_events_in_section field (8 bits) represents the number of events included in the table section.

A reserved field (2 bits) is a reserved area set to “11”.

An event_id field (16 bits) represents an ID number of an event to be described.

A start_time field (40 bits) represents the start time of the event using the Universal Time Coordinated (UTC).

An ETM_location field (2 bits) represents whether or not ETT text is applied to the current event.

A length_in_seconds field (20 bits) represents the duration of the event in seconds.

A title_length field (8 bits) represents the length of the next string.

A title_text field ( ) represents the structure of an encoded string of the title of the event.

A reserved field (4 bits) is a 4-bit reserved area.

A descriptors_length represents the length of subsequent descriptors.

The ad_segment_descriptor( ) illustrated above can be included in a descriptor( ) field so that a replaceable segment can be described according to each event ID. Then, in the case where a receiver having a storage function stores content, the receiver can skip storage of a specific segment, for example a segment including an undesired advertisement, among segments of the content.

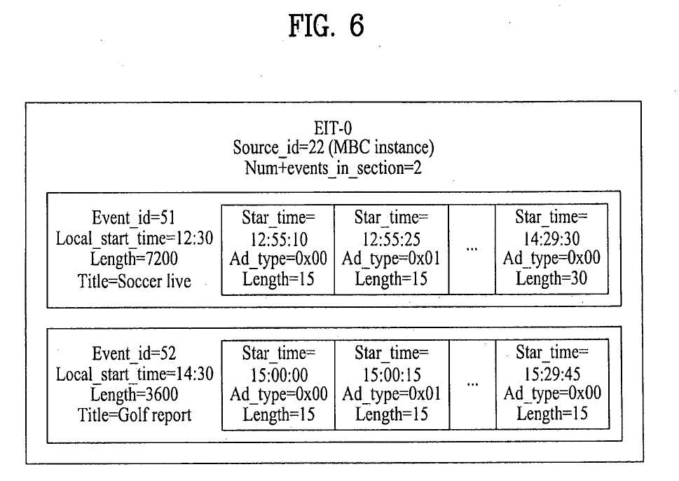

FIG. 6 illustrates an example of the EIT when description information of a replaceable segment is transmitted through the EIT. For example, it is assumed that a descriptor describing a replaceable segment is included in a table section that carries information of events in 3 hours from the present time.

“EIT-0” is event information of a source ID of “22” and describes information of 2 events of a corresponding time zone (num_events_in_section).

An event with an event_id of “51” proceeds for 7200 seconds from the start time 12:30 and the title of the event is a live soccer. Each event includes several segments. One of the segments is a non-replaceable segment having a start time of “12:55:10”, an ad_type of “0x00” as a segment type, and a length of 15 seconds.

Another segment is a replaceable segment having a start time of “12:55:25”, an ad_type of “0x01”, and a length of 15 seconds. Another segment is a non-replaceable segment having a start time of “14:29:30”, an ad_type of “0x00”, and a length of 30 seconds.

An event with an event_id of “52” proceeds for 3600 seconds from the start time 14:30 and the title of the event is a golf report. Each event includes several segments. One of the segments is a non-replaceable segment having a start time of “15:00:00”, an ad_type of “0x00” as a segment type, and a length of 15 seconds.

Another segment is a replaceable segment having a start time of “15:00:15”, an ad_type of “0x01”, and a length of 15 seconds. Another segment is a non-replaceable segment having a start time of “15:29:45”, an ad_type of “0x00”, and a length of 15 seconds.

In the case where the event belongs to broadcast content that has already been completed, for example, a program such as drama or movie that has been previously recorded, the illustrated ad_segment_descriptor can be transmitted and received through the EIT. However, in the case where the event belongs to a live broadcast such as a sports event, a decision to insert a replaceable segment may be made several seconds before an actual advertisement broadcast and therefore it may be difficult to signal the replaceable segment, taking into consideration limited transfer rate and timing constraints of the PSIP.

In this case, the replaceable segment may be signaled using an ad_segment_descriptor in the PMT transmitted in a shorter transmission period than that of the EIT. For example, an ad_segment_descriptor may be transmitted in a video stream ES_info loop in the PMT.

Alternatively, an ad_segment_descriptor may be transmitted in a private date area in an adaptation field of a transport stream packet. A transport stream defined in the MPEG-2 system may include an adaptation field. Since this adaptation field has a length constraint, the adaptation field is suitable for transmitting a replaceable segment (for example, an advertisement segment), which is broadcast after a decision to broadcast the segment is abruptly made like a live broadcast, immediately before transmission of the segment. The adaptation field includes a stuffing area that is filled in the adaptation field to the full size of the adaptation field and an ad_segment_descriptor describing a replaceable segment may be transmitted in a private data format in the stuffing area. Accordingly, it is possible to efficiently transmit the ad_segment_descriptor without additional waste of bit rate. Alternatively, a separate table describing the replaceable segment may be transmitted.

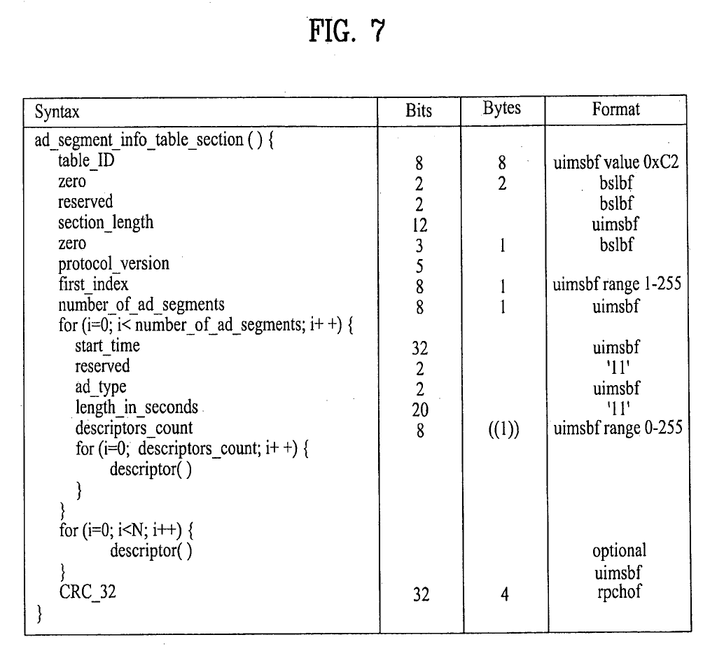

FIG. 7 illustrates an embodiment of an Ad_segment_info_table_section (AST) that describes a segment included in a broadcast stream illustrated above.

A table_id field (8 bits) represents an identifier of a table that describes a segment in the broadcast stream.

A zero field (2 bits) is a field set to “00” and a reserved field (2 bits) represents a reserved area.

A section_length field (12 bits) represents the length of the table section that describes the segment.

A zero field (3 bits) is a field set to “000” and a protocol_version field (8 bits) represents the protocol version of this table section.

A first_index field (8 bits) indicates the first of replaceable segments defined in this table section. If the replaceable segment is one or more records, a subsequent replaceable segment is defined by a table of a next index. For example, this field may have values of 1 to 255.

A number_of_ad_segments field (8 bits) indicates the number of segments.

The start_time field of each replaceable segment represents the start time of the replaceable segment. For example, in the start_time field, the start time of the replaceable segment can be set in seconds using the GPS time, namely, the number of seconds since 00:00:00 UTC Jan. 6, 1980.

The ad_type field represents the type of the segment. An example of this field is illustrated in FIG. 4.

The length_in_seconds field represents the duration of the replaceable segment. For example, the length_in_seconds field can represent the duration of the replaceable segment in seconds.

A descriptor_count field represents the number of descriptors describing information of each segment and a descriptor describing each segment may follow this field.

An additional descriptor for a segment may also be provided.

For example, when this table is transmitted from a PSIP system, the table can be identified using the following method. A packet ID of a stream including the above table may be signaled in a Master Guide Table (MGT). As the EIT table is signaled through an MGT, a PID including an AST describing segments included in the broadcast stream can be signaled through an MGT.

An additional stream_type for carrying an AST may also be defined. For example, the type of a stream that carries an AST may be set to “0x96” so that it is possible to identify the stream that carries the AST in a corresponding virtual channel.

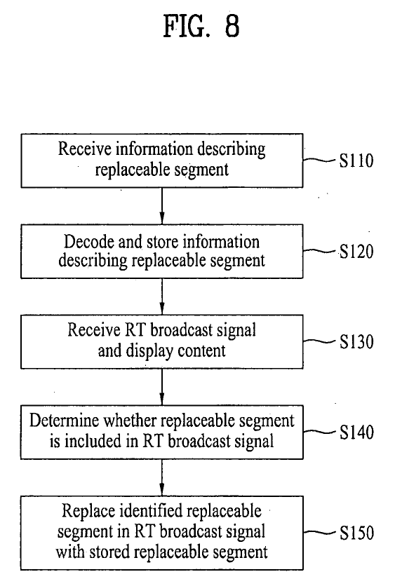

FIG. 8 illustrates an embodiment of a method for receiving broadcast signals according to the present invention. The following is a description of the embodiment of the method for receiving broadcast signals.

First, information describing a replaceable segment is received (S110). As described above, the information describing the replaceable segment may be included in a table section, may be provided through a descriptor included in a table section, or may be included in a specific field of a video stream. For example, the information describing the replaceable segment may describe a service that, while a user is watching a specific broadcast program, will be provided through a broadcast signal, regardless of the specific broadcast program. The replaceable segment may include information regarding the start time, the type, the duration, and the end time of the segment.

The information describing the replaceable segment is then decoded and stored (S120). For example, description information of the replaceable segment in a descriptor format described above can be parsed. Then, it is possible to identify the replaceable segment in a broadcast signal that will be transmitted in the future.

A RT broadcast signal is received and content transmitted via the broadcast signal is displayed (S130). Here, it is assumed that a replaceable segment received through an NRT broadcast signal may be stored before the RT broadcast signal is received. It is determined whether or not a replaceable segment is included in the RT broadcast signal (S140). Using the information describing the replaceable segment described above, it is possible to identify the replaceable segment in the RT broadcast signal.

The identified replaceable segment in the RT broadcast signal is replaced with the stored replaceable segment (S150). If no replaceable segment is present in the RT broadcast signal, content transmitted via the broadcast signal continues to be displayed.

Using this method, it is possible to identify a replaceable segment in a broadcast signal and the replaceable segment can be seamlessly inserted into the broadcast signal for replacement. Accordingly, it is possible to easily implement a service such as target advertising. Then, the broadcast receiver can display a broadcast signal which appropriately combines a non-RT service and an RT service.

Although a portion of an RT broadcast signal is replaced with a previously stored segment in the above embodiment, not only an RT broadcast signal but also a portion of previously stored content may be replaced with the previously stored segment. In the case where broadcast content previously stored in the receiver is reproduced after a replaceable segment is received in non-real time, the user can reproduce the stored broadcast content by replacing a portion of the broadcast content with the replaceable segment.

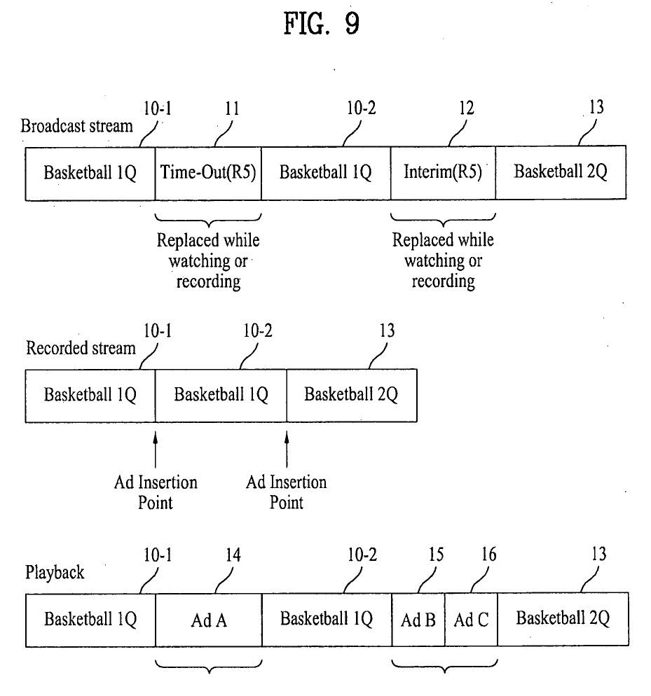

FIG. 9 illustrates an example wherein a portion of broadcast content is replaced with a replacement segment when the broadcast content is reproduced.

For example, let us assume that the user is receiving a broadcast stream regarding a basketball game in real time. In FIG. 9, two first quarter events 10-1 and 10-2, a first quarter timeout event 11, an interim event between first and second quarters 12, and a second quarter event 13 are illustrated as events that may occur during the basketball game.

When the user desires to record only scenes, during which the basketball game is being played, in content that is being broadcast in real time in a storage medium in the receiver, it is possible to allow the receiver not to record the timeout event 11 and the interim event 12. The broadcasting side can transmit information indicating that the timeout event 11 and the interim event 12 are replaceable segments in a broadcast signal. Embodiments that enable identification of the replaceable segment in a broadcast signal have already been described in the above description.

If the timeout event 11 and the interim event 12 are not stored in the receiver, the stored broadcast stream will include the first quarter event 10-1, the first quarter event 10-2, and the second quarter event 13. In the case where the broadcast receiver stores this broadcast stream, the broadcast receiver can separately store a time point for insertion of broadcast content between the first quarter events 10-1 and 10-2 and a time point for insertion of broadcast content between the first quarter event 10-2 and the second quarter event 13.

For example, a broadcast receiver including a PVR function can additionally generate metadata in order to support trick play etc. Here, the metadata, which is also referred to as an “index”, is information regarding a time point for skipping or a time point for insertion so that it is possible to skip a specific segment in a broadcast stream to be stored and to insert another segment into the broadcast stream. For example, the metadata or index may be information regarding the start position of a frame or field of specific video data. One method of representing the start position is to represent the start position using a transport packet(s). For example, when a jump function is performed using an I picture, the index may include pointer information of the position of a transport packet at which a next I picture starts. The index or metadata may also be transmitted through information such as identification information of a replaceable segment from the broadcasting side.

In the case where the broadcast receiver reproduces a stored broadcast stream, a specific broadcast segment may be inserted at the time point for insertion of specific broadcast content described above according to an algorithm set by the user.

In the example of FIG. 9, advertisement clips A, B, and C are inserted into a stored broadcast stream so that the first quarter event 10-1, an advertisement clip A 14, the first quarter event 10-2, an advertisement clip B 15, an advertisement clip C 16, and the second quarter event 13 can be reproduced in the named order. An advertisement clip to be reproduced can be selected based on the degree of user preference or other factors using an internal algorithm of the receiver. Here, the sum of the durations of reproduction of one or more advertisement clips that are selected to be reproduced is not necessarily equal to the duration of the replaceable segment. And the number of clips to be reproduced during the duration of the replaceable segment is not necessarily limited to a specific number. The data storage methods or the file formats of the first quarter event 10-1, the first quarter event 10-2, the second quarter event 13, the advertisement clip A 14, the advertisement clip B 15, and the advertisement clip C 16 of the broadcast stream to be reproduced need not be identical.

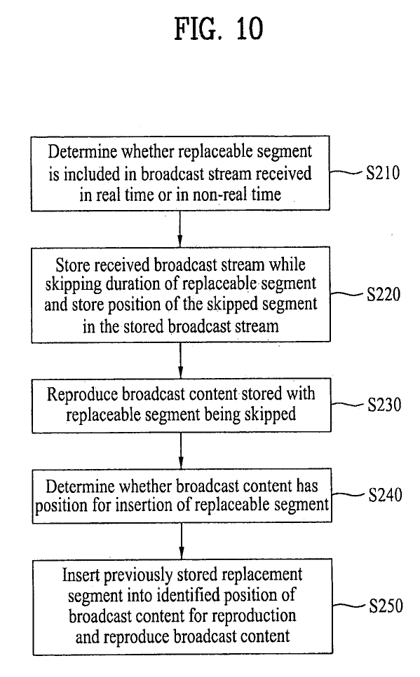

FIG. 10 illustrates an example wherein content received through an RT or NRT broadcast signal is stored while skipping storage of a replaceable segment included in the content, and the replaceable segment is replaced with content that is previously stored after being received through an NRT broadcast signal.

Specifically, first, a broadcast stream is received in real time or in non-real time and the received stream is stored. It is then determined whether or not a replaceable segment is included in the broadcast stream received in real time or in non-real time (S210). An example of the identification of a replaceable segment is illustrated above.

If a replaceable segment is included in the received broadcast stream, the broadcast stream is stored with the replaceable segment skipped, and position information of the interval of the replaceable segment is stored (S220). The position information of the interval of the replaceable segment may be previously transmitted from the transmitting side, and may also be generated by the broadcast receiver as metadata and then be stored separately from the replaceable segment. For example, the broadcast receiver may generate an index (metadata) in units of transport packets and may separately store the generated index (metadata).

The stored broadcast content in which the replaceable segment is skipped, is then reproduced (S230).

When the broadcast content is reproduced, it is possible to determine whether or not the broadcast content has a position at which a replaceable segment is to be inserted into the broadcast content (S240). From the received or stored index or metadata, it is possible to identify position information of the interval of the segment to be inserted into the content to be reproduced. For example, the index (metadata) may be generated in units of transport packets and the generated index (metadata) may be stored separately.

If a position in the broadcast content for reproduction at which the segment is to be inserted into the broadcast content is identified, then uploading of the broadcast content for reproduction is temporarily stopped and the stored replacement segment is reproduced, so that the replacement segment is inserted into the broadcast content at the identified position. That is, the broadcast content with the segment inserted therein is reproduced (S250). A replacement segment can be extracted and reproduced with reference to the index or metadata for the replaceable segment and time information corresponding to a position at which the segment is to be inserted in the broadcast content for reproduction. Here, the length of the segment to be inserted need not be limited to a specific length. When a skipped segment and a replacement segment are reproduced in the same time interval, the index or metadata may include time information of NRT content (i.e., a replacement segment).

When all inserted segments have been reproduced, reproduction of the original stored broadcast content is resumed. A reproduction-related position pointer of broadcast content may indicate a time position at which broadcast content will be uploaded in the future, thereby enabling smooth or reliable reproduction of the broadcast content. For example, a reproduction-related position pointer may indicate the position of a Transport Packet (TP) for re-uploading. The reproduction-related position pointer may also include information of a next position pointer and thus it is possible to previously know the time for reproduction by the broadcast receiver.

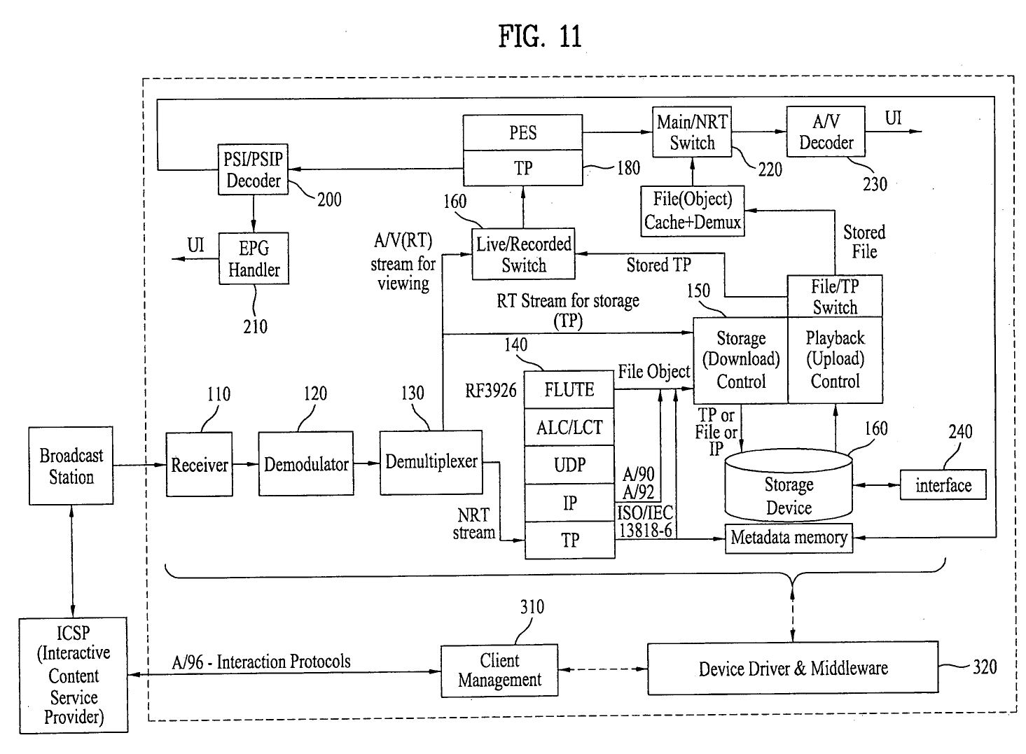

FIG. 11 illustrates an embodiment of an apparatus for receiving broadcast signals. The embodiment can display content (or segment) that has been received through an NRT broadcast signal, by replacing with a replacement segment.

The embodiment of the apparatus for receiving broadcast signals includes a receiving unit 110, a demodulation unit 120, a demultiplexing unit 130, a signal parsing unit (file decoder) 140, a storage controller 150, a temporary storage unit 155, a storage device 160, a first switching unit 170, a packet processing unit 180, a broadcast description information decoder 200, a broadcast information handler 210, a second switching unit 220, an A/V decoder 230, an interface 240, a manager 310, and a controller 320.

The receiving unit 110 receives, for example, a terrestrial broadcast signal and tunes to a desired channel in the broadcast signal. The receiving unit 110 can receive an RT stream and an NRT stream.

The demodulation unit 120 demodulates the received broadcast signal of the channel. For example, when the demodulation unit 120 is a VSB-modulated signal, the demodulation unit 120 performs VSB demodulation on the broadcast signal.

The demultiplexing unit 130 can demultiplex the broadcast signal into an RT stream and an NRT stream and can output the streams.

The file decoder 140 can decode a received file including content transmitted in non-real time. The content transmitted in non-real time may be transmitted in a Transport Packet (TP) or an IP packet, or in a file format. Here, the content transmitted in non-real time may be received in a Transport Packet (TP) or an IP packet, or in a file included in a TP or IP packet.

The file decoder 140 illustrated in FIG. 11 may decode NRT content or metadata included in a TP or an IP packet. The file decoder 140 may also decode metadata or a content file object included in an IP packet in a Transport Packet (TP). For example, the TP may be parsed according to ISP/IEC 13818-6 DSM-CC and an IP packet may be included in the TP according to ATSC A/90 or A/92. The file decoder 140 may also decode metadata or NRT content in a file format included in a transport stream. The content file object can be encapsulated using UDP, ALC/LCT, or FLUTE according to RFC3926. The file decoder 140 can decapsulate the encapsulated file object. Thus, the file decoder 140 can obtain broadcast content or metadata included in a TP, an IP packet, or a file object.

An index or metadata may be received in a PSIP of a TP, an IP packet, or a file format and stored in a broadcast receiver or may be generated by the storage controller 150 in the apparatus for receiving broadcast signals and then may be stored in a metadata storage unit 162.

The storage controller 150 can store content received in real time or store content received in non-real time or upload stored content.

The storage controller 150 may include a download controller that controls downloading of content and an upload controller that reproduces content stored in the storage device 160. The upload controller may include a switch unit that reproduces a stored file or packets. Thus, the storage controller 150 can implement a PVR function and can generate and store an index or metadata in the metadata storage unit 162.

The first switching unit 170 selectively outputs an RT stream demultiplexed by the demultiplexing unit 130 or a packet uploaded by the storage controller 150 to the packet processing unit 180.

The packet processing unit 180 can separate broadcast description information such as PSI/PSIP from a transport packet and can reconstruct a transport packet into a PES. If replacement segment description information is included in a video stream packet, the packet processing unit 180 can obtain the replacement segment description information from the video stream packet.

The broadcast description information decoder 200 can decode the broadcast description information output by the packet processing unit 180. The broadcast description information decoder 200 can decode and store metadata received through the PSI/PSIP and can decode event information. The broadcast description information decoder 200 can decode replacement segment description information received through an NRT broadcast signal. For example, when segment-related information describing a replaceable segment included in a broadcast signal is included in an EIT or PMT, the broadcast description information decoder 200 can decode the segment-related information. In FIG. 11, an ad_segment_descriptor( ) is illustrated as an example of the segment-related information.

The broadcast information handler 210 can collect event information of the broadcast signal and provide broadcast information including the event information to the user.

On the other hand, a file uploaded by the storage controller 150 is output to the second switching unit 220 after being stored in the temporary storage unit 155.

The temporary storage unit 155 can temporarily store NRT content that will be inserted in order to easily upload the NRT content. Particularly, the temporary storage unit 155 can previously cache NRT content of a replacement segment or the like for uploading with reference to replacement segment description information to cope with the case where the storage device 160 uploads the replacement segment without securing sufficient time.

The second switching unit 220 can selectively output an NRT content file uploaded by the storage controller 150 or a stream output by the packet processing unit 180.

In the case where content received in non-real time is inserted into a stream received in real time, the second switching unit 220 can selectively output the RT stream and the content stored in non-real time with reference to replacement segment description information.

In the case where a segment received in non-real time is inserted into a specific portion (for example, segment) in content reproduced after being stored, the second switching unit 220 can selectively output the segment received in non-real time in the specific portion in the reproduced content with reference to a stored index or metadata.

The A/V decoder 230 can decode and output A/V data included in a file or stream selectively output by the second switching unit 220.

The interface 240 can receive and process a variety of control signals from the user. For example, the interface 240 can receive selection information of content selected by the user and can also store the user selection information.

On the other hand, the storage controller 150 can store or upload corresponding content according to the user selection information received from the interface 240 and can store a corresponding index or metadata.

The manager 310 can communicate with a content service provider using an interactive protocol such as the Internet protocol and can receive files transmitted in real time or in non-real time such as files of Internet broadcasts from the content service provider.

The controller 320 can control building blocks of the apparatus for receiving broadcast signals, including the manager 310, and can drive middleware or the like for providing broadcast services. For example, the controller 320 controls the storage controller 150 to upload the stored data including broadcast stream, the replacement segment, and the segment-related information. And the controller 320 controls the storage controller 150 to download an RT stream or a NRT stream. And, for example, the controller 320 controls the storage controller 150, the storage device 160, and the switching units 160 and 220 to insert the stored replacement segment into a specific portion of the broadcasting stream according to segment-related information.

The controller 320 can drive an algorithm according to content selection information of the user to perform a control operation to enable insertion of content received in non-real time desired by the user. The controller 320 can drive a variety of algorithms. In the present invention, it is assumed that a detailed algorithm is not implemented and content for insertion is determined according to the algorithm.

According to the embodiments of the present invention, content received in non-real time can be easily inserted into a stream received in real time or into content for reproduction.

According to the embodiments of the present invention, a replaceable segment can be described and signaled in a stream received in real time to enable insertion of content received in non-real time.

According to the embodiments of the present invention, in the case where content received in non-real time is inserted into content for reproduction, an index or metadata indicating the time point for insertion can be received or generated and stored.

According to the embodiments of the present invention, it is possible to provide an individual-customized service and to provide a variety of services to each individual according to the preference of the individual.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of receiving broadcast signals by a broadcast receiver including a storage medium, the method comprising:
receiving a replacement segment to replace a specific portion of a broadcast stream, and segment-related information describing the replaceable segment included in a broadcast stream;
receiving a broadcast stream;
inserting the stored replacement segment into the received broadcast stream using the segment-related information; and
displaying the broadcast stream with the inserted replacement segment.

2. The method according to claim 1, wherein the segment-related information includes position information of the replaceable segment in the broadcast stream, and the receiving of the broadcast stream includes identifying the replaceable segment and storing the broadcast stream in which the identified replaceable segment is skipped.

3. The method according to claim 2, wherein the segment-related information is received through one of a transport packet, an IP packet, and a file object in the received broadcast stream.

4. The method according to claim 1, wherein the segment-related information includes a start time of a replaceable segment in the broadcast stream, a type of the replaceable segment, and duration of the replaceable segment.

5. The method according to claim 1, wherein the segment-related information is included in one of an Event Information Table (EIT), a Program Map Table (PMT), and a video stream packet.

6. The method according to claim 1, wherein the segment-related information is defined by a table of broadcast description information and is transmitted via a table section.

7. The method according to claim 6, wherein an identifier of a packet through which the table section is transmitted is included in Master Guide Table (MGT).

8. The method according to claim 6, wherein the table is transmitted through a stream defined by a separate stream_type.

9. An apparatus for receiving broadcast signals, the apparatus comprising:
a receiving unit configured to receive a broadcast signal;
a demodulator configured to demodulate the broadcast signal;
a demultiplexer configured to demultiplex the broadcast signal;
a storage device configured to store a replacement segment to replace a specific portion of a broadcast stream, and segment-related information describing a replaceable segment included in a broadcast stream, from the demultiplexed broadcast signal;
a controller configured to control uploading the stored replacement segment or downloading the replacement segment and to insert the stored replacement segment into the broadcast stream according to the segment-related information; and
a decoder configured to decode a broadcast stream.

10. The apparatus according to claim 9, wherein, when the broadcast stream is stored in the storage device, the controller controls the storage device to store the broadcast stream in which a replaceable segment included in the broadcast stream is skipped.

11. The apparatus according to claim 10, wherein, when the controller uploads the stored broadcast stream from the storage device, the segment-related information includes information pointer information indicating a position for insertion of the replacement segment.

12. The apparatus according to claim 11, wherein the controller stores the segment-related information in the storage device.

13. The apparatus according to claim 9, wherein the segment-related information includes a start time of a replaceable segment in the broadcast stream, a type of the replaceable segment, and duration of the replaceable segment.

14. The apparatus according to claim 13, wherein the segment-related information is included in one of an Event Information Table (EIT), a Program Map Table (PMT), and a video stream packet.

15. The apparatus according to claim 13, wherein the segment-related information is defined by a table of broadcast description information and is transmitted through a table section.

16. The apparatus according to claim 9, wherein the segment-related information is received in the broadcast stream or is generated by a storage controller controlling the storage.

17. The apparatus according to claim 16, wherein the segment-related information indicates a position of a transport packet at which an IP picture starts.

18. The apparatus according to claim 16, wherein, when the segment-related information is included in the broadcast signal, the apparatus further comprises a file decoder that decodes the replacement segment and the file decoder decodes the segment-related information included in one of a transport packet, an IP packet, and a file object.
